(19) United States
(12) Patent Application Publication
(10) Pub. No.: US 2021/0065149 A1
(43) Pub. Date: Mar. 4, 2021

(54) Vending System and Method

(71) Applicant: TTI Club, LLC, Frisco, TX (US)

(72) Inventors: Sanford Mark Sellers, The Colony, TX (US); Kevin Blaine Ferguson, Mabank, TX (US)

(21) Appl. No.: 17/005,083

(22) Filed: Aug. 27, 2020

Related U.S. Application Data
(60) Provisional application No. 62/893,619, filed on Aug. 29, 2019.

(51) Int. Cl. G06Q 20/18; G06Q 20/32

(52) U.S. Cl. CPC G06Q 20/18; G06Q 20/3255

(57) ABSTRACT

In an embodiment, a method includes: receiving a short message service (SMS) text message from a first user, the SMS text message including a vending token for a vending machine and a source phone number of the first user; obtaining user data associated with the source phone number; determining whether the vending token may be redeemed by the first user according to the user data; and vending a product to the first user from the vending machine in response to determining the vending token may be redeemed by the first user, the vending being performed without requiring payment by the first user to the vending machine at the time of the vending.

### PRIORITY CLAIM

This application claims the benefit of U.S. Provisional Application No. 62/893,619, filed on Aug. 29, 2019, which application is hereby incorporated herein by reference

### BACKGROUND

Vending machines allow the dispensing of items such as snacks, beverages, cigarettes, ice, newspapers, or the like to users. Traditional vending machines are coin-operated, and dispense a product to a customer upon payment by the customer. More recently, modern technologies are being incorporated into vending machines. For example, modern vending machines can include more advanced payment systems, internet connectivity, cameras, or the like.

### SUMMARY

In an embodiment, a method includes: receiving a short message service (SMS) text message from a first user, the SMS text message including a vending token for a vending machine and a source phone number of the first user; obtaining user data associated with the source phone number; determining whether the vending token may be redeemed by the first user according to the user data; and vending a product to the first user from the vending machine in response to determining the vending token may be redeemed by the first user, the vending being performed without requiring payment by the first user to the vending machine at the time of the vending.

In some embodiments of the method, the SMS text message further includes a destination phone number of the vending machine, and vending the product to the first user from the vending machine includes: obtaining vending machine data associated with the destination phone number; selecting a first interface type for the vending machine from a plurality of interface types according to the vending machine data; and transmitting a vend command to the vending machine according to the first interface type. In some embodiments, the method further includes: determining a destination for the vending machine according to the vending machine data, where transmitting the vend command to the vending machine includes transmitting the vend command to the destination. In some embodiments of the method, the destination includes an Internet Protocol address and a port number. In some embodiments of the method, the source phone number and the destination phone number are long code numbers. In some embodiments of the method, determining whether the vending token may be redeemed by the first user includes: determining a remaining quantity of free vends associated with the vending token; determining the vending token may be redeemed by the first user in response to the remaining quantity of free vends being greater than zero; and determining the vending token may not be redeemed by the first user in response to the remaining quantity of free vends being less than or equal to zero. In some embodiments, the method further includes: decrementing the remaining quantity of free vends. In some embodiments of the method, determining whether the vending token may be redeemed by the first user includes: determining authorized users associated with the vending token; determining the vending token may be redeemed by the first user in response to the first user being one of the authorized users; and determining the vending token may not be redeemed by the first user in response to the first user not being one of the authorized users. In some embodiments, the method further includes: incrementing a usage counter associated with the vending token; and generating a bill for the first user according to the usage counter of the vending token. In some embodiments of the method, determining whether the vending token may be redeemed by the first user includes: determining a reward point counter associated with the vending token; determining the vending token may be redeemed by the first user in response to the reward point counter being greater than or equal to a predetermined threshold; and determining the vending token may not be redeemed by the first user in response to the reward point counter being less than the predetermined threshold. In some embodiments, the method further includes: validating a purchase by the first user at the vending machine; and incrementing the reward point counter associated with the vending token in response to validating the purchase. In some embodiments of the method, determining whether the vending token may be redeemed by the first user includes: determining whether the vending token was issued to a second user and whether the first user has previously redeemed the vending token; determining the vending token may be redeemed by the first user in response to the vending token being issued to the second user and the first user having not previously redeemed the vending token; and determining the vending token may not be redeemed by the first user in response to the vending token not being issued to the second user or the first user having previously redeemed the vending token. In some embodiments, the method further includes: incrementing a reward point counter associated with the vending token. In some embodiments of the method, determining whether the vending token may be redeemed by the first user includes: determining a valid time range associated with the vending token; determining the vending token may be redeemed by the first user in response to the time of the vending being in the valid time range; and determining the vending token may not be redeemed by the first user in response to the time of the vending not being in the valid time range.

In an embodiment, a method includes: receiving a message including a vending token, a source phone number, and a destination phone number; determining a user associated with the source phone number; determining a vending machine associated with the destination phone number; determining whether the user is permitted to redeem the vending token for a free vend of a product from the vending machine; vending the product to the user from the vending machine in response to determining the user is permitted to redeem the vending token, where vending the product includes: selecting a first interface type for the vending machine from a plurality of interface types; determining a destination address for the vending machine; and transmitting a vend command to the destination address according to the first interface type.

In some embodiments of the method, the message is a short message service (SMS) text message. In some embodiments of the method, the message is an email. In some embodiments of the method, the message is an input from an interactive voice response system.

In an embodiment, a method includes: receiving a first message including a first vending token and a first destination phone number; obtaining first user data associated with the first vending token, the first user data including a first reward point counter for a first user; obtaining first vending machine data associated with the first destination phone number, the first vending machine data including a first destination address and a first interface type for a first vending machine; determining whether the first user is permitted to redeem the first vending token for a free vend of a product from the first vending machine; and transmitting a first vend command to the first destination address according to the first interface type in response to determining the first user is permitted to redeem the first vending token.

In some embodiments, the method further includes: receiving a second message including a second vending token and a second destination phone number; obtaining second user data associated with the second vending token, the second user data including a second reward point counter for a second user; obtaining second vending machine data associated with the second destination phone number, the second vending machine data including a second destination address and a second interface type for a second vending machine; determining whether the second user is permitted to redeem the second vending token for a free vend of a product from the second vending machine; and transmitting a second vend command to the second destination address according to the second interface type in response to determining the second user is permitted to redeem the second vending token, where the first interface type is different from the second interface type. In some embodiments, the method further includes: receiving a second message including a second vending token and a second destination phone number; obtaining second user data associated with the second vending token, the second user data including a second reward point counter for a second user; obtaining second vending machine data associated with the second destination phone number, the second vending machine data including a second destination address and a second interface type for a second vending machine; determining whether the second user is permitted to redeem the second vending token for a free vend of a product from the second vending machine; and transmitting a second vend command to the second destination address according to the second interface type in response to determining the second user is permitted to redeem the second vending token, where the first interface type and the second interface type are the same interface type.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a system for short message service (SMS) text message vending, in accordance with some embodiments;

FIG. 2 is a flow diagram of a method for processing text tokens, in accordance with some embodiments;

FIGS. 3A and 3B are a flow diagram of a method for processing loyalty tokens, in accordance with some embodiments;

FIG. 4 is a block diagram of a loyalty service, in accordance with some embodiments; and

FIG. 5 is a block diagram of a processing system, in accordance with some embodiments.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

In accordance with some embodiments, SMS text messaging is used to vend a product from a vending machine. Specifically, SMS text messaging is used as part of a transaction system which enables a customer to initiate a product vend without payment (e.g., free to the customer) using SMS. For example, free product vends may be initiated by SMS text message to allow a potential customer to “try before they buy” in order to capture them as new customers. The use of SMS text messaging for free vending may be lower in cost than traditional free vending markers such as metal tokens or paper coupons. Further, the use of SMS text messaging can help ensure free vends are redeemed at the proper vending machine, helping steer potential customers away from competing vending machines and reducing potential customer losses.

In accordance with some embodiments, SMS text messages, like traditional tokens or coupons, allow a customer to receive a vend product without a payment. Unlike traditional tokens and coupons, there is no potential for physical loss, and the tokens cannot be used in a competitor's vending machine. SMS text messages may be used to transmit short codes, such as alphanumeric codes, between the vendor (e.g., vending machine owner/operator) and a customer. Such messages may be referred to herein as “eTokens” or “vTokens.” Specifically, a token is an alphanumeric word or phrase that has specific attributes the system uses to perform an action.

Further, in accordance with some embodiments, the use of eTokens may be configured by a vendor. For example, a vendor may create and distribute free vend tokens, purchased tokens, refund tokens, recurring tokens, membership tokens, referral tokens, etc. Each type of token may be used to vend a product for a customer from a vending machine, without requiring direct payment by the customer to the vending machine at the time of vending. Each token can be unique for a vendor or for the entire system.

In some embodiments, membership tokens and referral tokens may be tracked as part of a loyalty or marketing program. As discussed further below, a membership token may be generated and associated with a member's phone number. The membership token may be sent or given to the user by sending an SMS text message to the member's phone number. A member may also personalize their code. Customer data such as the unique code, number of visits, number of reward points, and last visit may be tracked as the membership token is used by the customer. Further, other phone numbers besides the associated member's phone number may use a referral token given by the member. The use of referral tokens may allow for viral marketing of a vending machine or machines owned by a vendor. For example, a member may share his unique code with friends, family, on social media, etc. When a person other than the member uses the shared code at a participating vending machine, the potential new customer receives a free vend, and the member of the loyalty program receives a reward point toward a free vend. Once the number of reward points collected by the member reaches a configured value (e.g. 5), the member receives a free vend. In some embodiments, members can earn reward points through validated visits and referrals, which can encourage customer loyalty and incentivizes sharing of the member's code.

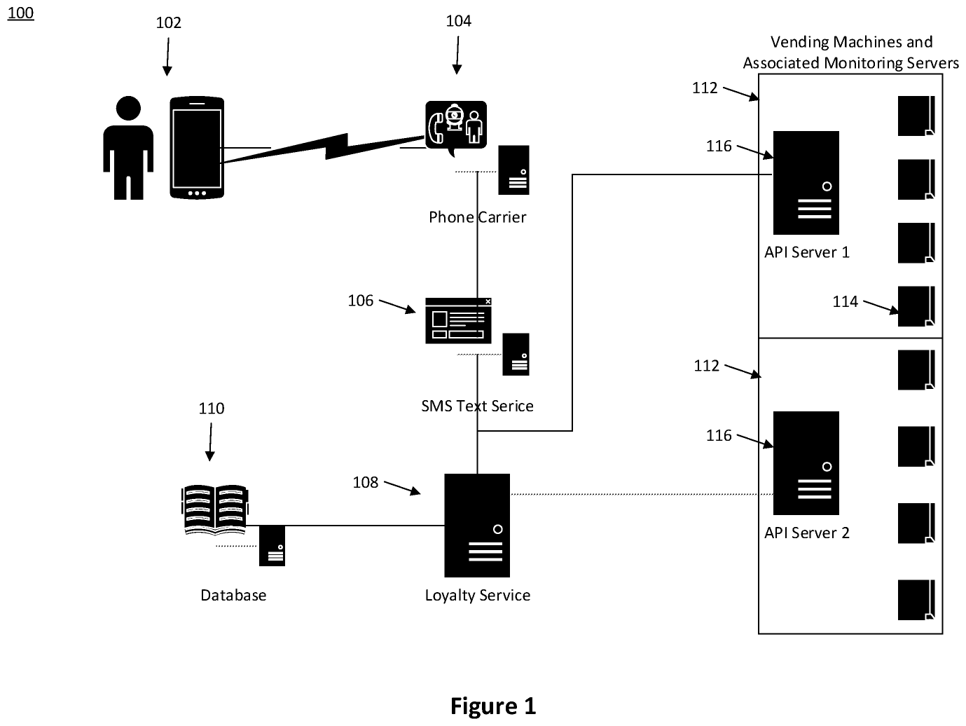

FIG. 1 is a block diagram of a system 100 for SMS text message vending, in accordance with some embodiments. The system 100 uses existing SMS Text Messaging systems to communicate with a customer. In the system 100, a text message sent by a customer's phone 102 goes to the customer's phone carrier 104. An SMS text service 106 provides an interface between the customer's phone carrier 104 and a back-end loyalty service 108. The SMS text service 106 can be part of the phone carrier 104, or could be a third party service. The loyalty service 108 receives the text message and processes it, and stores data in an associated database no. The loyalty service 108 communicates with vending facilities 112 to control individual vending machines 114. Communication may be directly between the loyalty service 108 and vending machines 114, or may be mediated by a vending machine monitoring system 116. For example, each vending facility 112 may have a vending machine monitoring system 116 that communicates with the loyalty service 108 by an application programming interface (API).

In some embodiments, the loyalty service 108 is a centralized loyalty service 108 used by many vending facilities 112 owned by different vendors. For example, the loyalty service 108 can be provided as part of a cloud service that many vendors are customers of, and one loyalty service 108 can control many vending facilities 112, with each vending facility 112 potentially being managed by different vendors.

The loyalty service 108 may control the vending machines 114 to, e.g., command a vend of a product in the vending machines 114. Specifically, the loyalty service 108 can send vend commands to the vending machines 114 in response to receiving a token from a customer's phone 102. Tokens can be configured in a variety of ways including, but not limited to, the following.

In some embodiments, the tokens are free vend tokens. For example, free vend tokens may be generated and used to advertise on social media, business cards, mailers, etc, to make potential customers aware of a vending location and offer a free product in a try-before-you-buy promotion.

In some embodiments, the tokens are refund tokens. For example, refund tokens may be given to customers when they have not received a product they paid for. Likewise, refund tokens may also be granted to unhappy customers that the vendor wishes to make happy with the experience. A refund token can be generated and associated with one or more free vends for the receiving customer. Issuing refund tokens may be faster for a vendor than mailing a check for the lost costs to a customer, and is faster and more convenient for the customer.

In some embodiments, the tokens are purchased tokens. For example, tokens may be pre-purchased in bulk by a particular customer, such as a restaurant, shop, etc., so that the token may be redeemed multiple times by the bearer of the token without needing to pay at the time of vending. Other users, such as employees of the token owner, may use the token to vend products. Similarly, the tokens may be billable tokens, where the token may be freely used by a customer and the customer billed for their usage at the end of a billing cycle.

In some embodiments, the tokens are member tokens. Member tokens may be used for a loyalty program by the vendor. A member may use their member token to earn reward points for each vend they purchase, and the member may redeem the reward points with their member token for a free vend. A member could also share their member token with friends, family, and on social media. This viral marketing aspect can help bring more potential customers to a vending machine for a free vend, in hopes they become regular customers. In exchange for referring, a member may receive further reward points for the use of the member token by other potential customers, thereby offering a reward for bringing in potential new customers.

In some embodiments, the tokens are promotional tokens. Similar to free vend tokens, promotional tokens can be configured based on a start, stop, and expiration date as well as a recurring date. For example, a vendor can advertise a promotion such as “FREE ON TUESDAY FROM 4:00 pm-8:00 pm,” and distribute a promotional token that only functions on the desired day and times and at particular vending machines owned by the vendor.

In some embodiments, the tokens are fundraiser tokens. Similar to loyalty tokens, fundraiser tokens do not issue free vends on their own, but rather serve as a tracking mechanism for paid vends. For example, a paying customer may provide a fundraiser token, which is associated with a sponsoring organization. The fundraiser token may be used to track purchases for the purpose of revenue sharing with the sponsoring organization by a vendor.

In some embodiments, the tokens are buy-one-get-one tokens. Similar to free vend tokens, buy-one-get-one tokens can issue a free vend, but first require the user to purchase a vend. A customer who is a member may visit a vending machine, purchase a vend, and then provide the buy-one-get-one token. Within a short time, the visit will be validated against a purchase, and the customer notified a the buy-one-get-one token may be redeemed for a free vend.

As noted above, the loyalty service 108 associates a token with the number of a customer's phone 102. Such association allows a vendor to control the number of times a customer can redeem a token for a free vend. For example, each phone number may have a limited number of free vends that is controlled by the system and the vendor. If a customer tries to redeem a token beyond its limit, the customer is told there are no more free items available for that token.

Text token allow a variety of loyalty programs to be operated in the system loft Like many loyalty programs, rewarding customers for being loyal to the vendor's brand or location helps motivate the customer to come back, knowing he or she will earn reward points. To help vendors recruit new customers, customers are incented to share their tokens to earn reward points if a referred customer uses their member token. Upon successful referral, members receive reward points towards free vends, and the referred customer receives a free vend and hopefully becomes a regular customer and member.

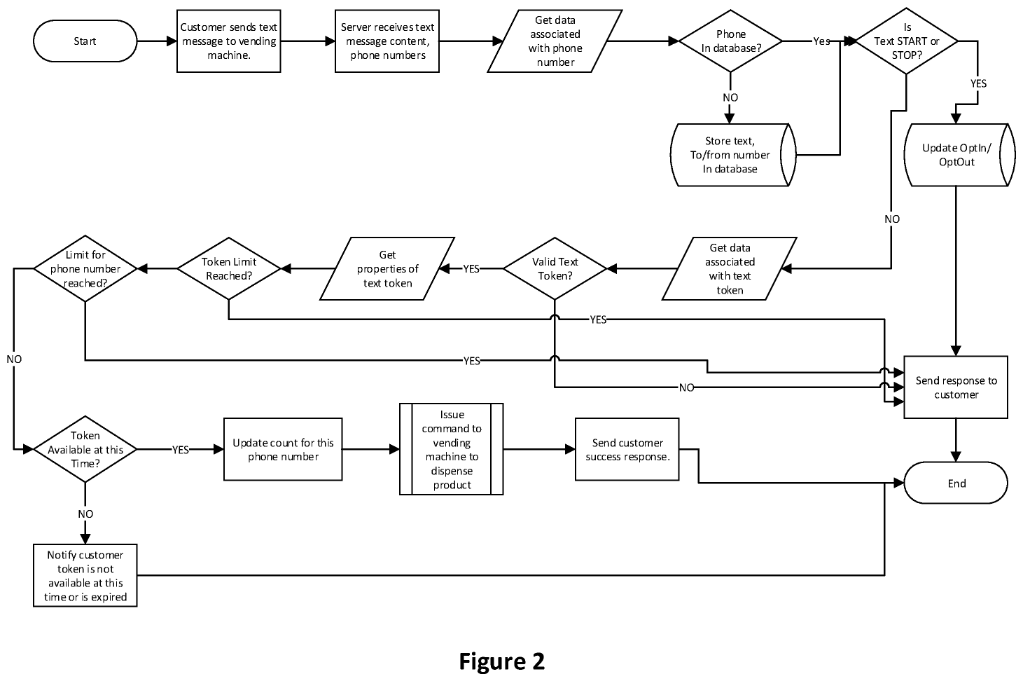

FIG. 2 is a flow diagram of a method for processing loyalty tokens, in accordance with some embodiments. A token is included with a text message sent from a customer to the system. Initially, a customer sends a text to the system. The text message includes the vending token, a source phone number (e.g., corresponding to the customer's phone), and a destination phone number (e.g., corresponding to the vending machine). The text message comprises the source phone number in that the system knows what phone number the text message was sent from. The text message comprises the destination phone number in that the system knows what phone number the text message was sent to. The source and destination phone numbers may each be long code numbers. Alternatively, the source phone number may be a long code number, and the destination phone number may be a short code number. In some embodiments, the text message may also include additional information, such as a password for the user. If the customer is new, then the customer is added to the database. If the text is START or STOP, then the system processing opting-in or opting-out of text messages, as may be required by the customer's phone company. If the text is a text token, then the token is validated for limits, time ranges, start/expiration time(s), repeated usage, etc. If token can't be used, then the customer is notified. If the token can be used, then a vend command is transmitted to the desired vending machine and the customer data and token data is updated to reflect the use of the token. Free vend tokens, refund tokens, and purchased tokens are all part of this system allowing for this functionality. Any actions stored in the database for the customer and used by the customer can be incremented/decremented upon vend. For example, a customer's count of reward points may be incremented upon a purchase. As noted above, phone numbers are used as unique keys identifying a customer and the customer's activity to limit the number of free vends based on the token configuration. Messages responses can be sent as text messages to the customer to explain what was done, such as vending a free item.

As noted above, vending at a desired vending machine may be accomplished by transmitting a vend command to the vending machine. Also as noted above, the loyalty service 108 can be used by multiple vendors. Different vendors may use different makes and models of vending machines. Different makes and models of vending machines may use different APIs. Thus, different interface types may be used for different vending machines. In some embodiments, vending at a vending machine includes selecting the interface type of the vending machine from a plurality of known interface types, each corresponding to different vending machine. A destination address (e.g., Internet Protocol address and port number) for the vending machine may also be determined. The interface type and destination address for the vending machine may be determined from the database. For example, as noted above, an incoming text message includes a destination phone number for the vending machine. Determining the interface type and destination address for the vending machine can include obtaining vending machine data associated with the destination phone number (e.g., by looking up the vending machine data in the database using the destination phone number). The vend command is transmitted to the determined destination address according to the determined interface type.

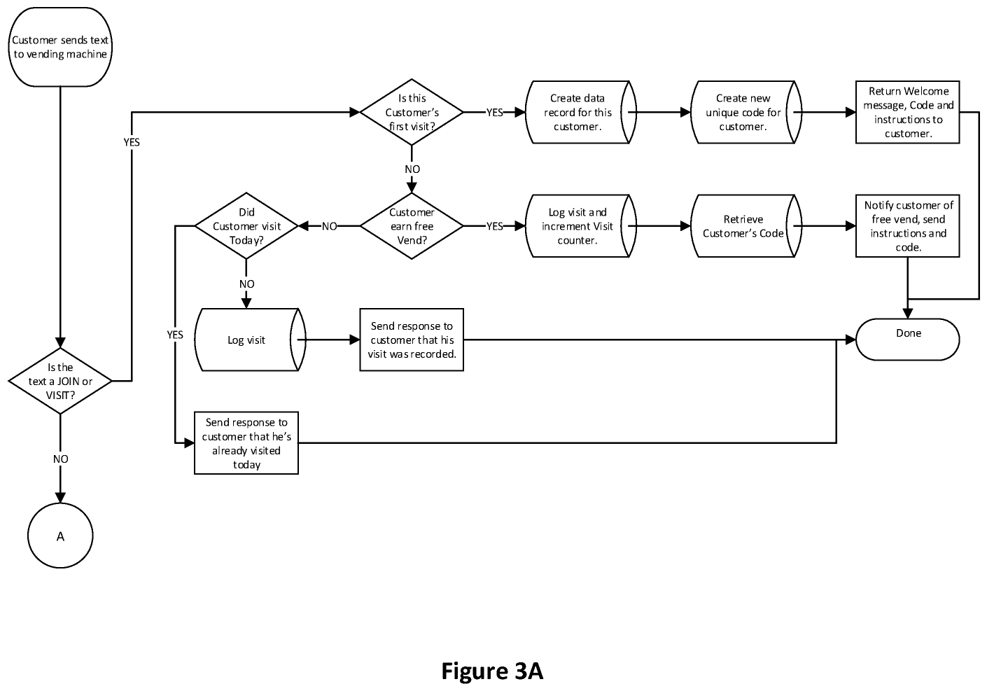

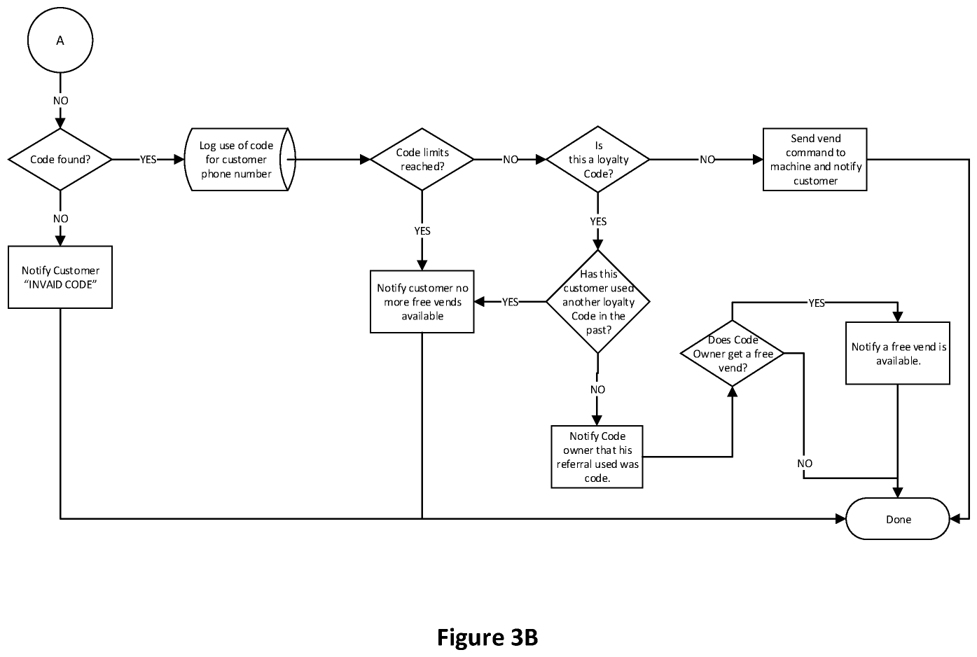

FIGS. 3A and 3B are a flow diagram of a method for processing loyalty tokens, in accordance with some embodiments. A customer can be signed up for the loyalty program and a unique code returned to the customer. A customer's “visit” to a vending machine and associated purchase is recorded. As noted above, a customer's unique code may be used by non-loyalty program customers as a referral, and a customer may receive reward points based on visits and referrals. Finally, a customer is rewarded with a free vend when the customer's reward point total reaches a specified and configurable value (e.g. 5 visits with a purchase). The values may be configured by each vendor.

Initially, in FIGS. 3A and 3B, a customer sends a text message to the loyalty service 108. Upon receipt of a message, the loyalty service 108 determines if the message is a join, visit, unique customer code, virtual token (e.g., free vend token, refund token, purchased token, member token, promotional token, fundraiser token, or the like), or an approved alias thereof. If the message is a join or visit, the system obtains user data associated with the source phone number of the message and determines if the customer is already a member or if this is a signup to become a member. For example, the user data may be looked up using the source phone number, the user's token (e.g., alphanumeric code), the user's password, combinations thereof, or the like. If the customer not yet a member, then the customer is signed up as a member and sent appropriate text responses as well as the customer's unique code. The customer can keep this code or can personalize it via a web interface to the loyalty service 108. The new member is encouraged to share this code to earn reward payments faster.

If the customer is already a member and this member is visiting, then the member visit is recorded in the user data for the customer. Within a short time, the visit will be validated against a purchase in order to obtain reward payments. If no purchase if found, then the member is notified that he or she must record their visit with a text message at the time they purchase in order to get a credit. A reward point counter associated with the member's unique code is incremented in response to validating the purchase.

The system then determines whether the vending token may be redeemed by the customer. If a member's unique code is sent, then the phone number is compared against the member's phone number. If the phone number matches, then the loyalty service 108 knows the member is trying to redeem a free vend. If enough reward points are available, a vend credit is issued and the appropriate number of reward points are deducted from the reward point counter associated with the member's account. In some embodiments, determining if enough reward points are available includes determining (e.g., looking up) the reward point counter associated with the member's unique code. If the reward point counter is greater than or equal to a predetermined threshold (e.g., 5), then the vending token is permitted to be redeemed for a free vend. If the sending phone number is not the member's phone number (e.g., if the code was issued to another member), then it is assumed the sender is a friend (referral) of the member. The customer will receive a free vend if this is the first time he or she has used (redeemed) another member's unique code. Upon a successful free vend, the member also gets a credit added to his account for referring someone to the vending machine.

If the code sent is a token such as a free vend, the customer will be matched in the database to make sure the same phone number has not redeemed this token at another time. If so, the limit of the token is compared against the number of times the customer has used the token and if the limit is reached, the customer is told that this token has no more free vends available. Otherwise, a free vend is issued for the customer.

Purchased vends, much like free vends, are when a customer has purchased a block of vends from the vendor. The customer may purchase as many vends as he or she wants to pay for in advance and then redeem the virtual token or purchased token for the number of vends purchased.

Each of the transactions discussed with respect to FIGS. 3A and 3B is kept track of and reported in a database. At any point in time, a customer, a member, or a vendor may view data pertaining to their account. For example, a customer may view their reward point total, or a vendor may view the number of members a given vending machine 114 has.

The embodiment described with respect to FIGS. 2, 3A, and 3B is an example of a method for processing loyalty tokens. Variations of the method may be used to process other types of vending tokens.

In embodiments where the vending tokens are free vend tokens, refund tokens, or pre-purchased tokens, determining whether the vending token may be redeemed by the customer can include determining a remaining quantity of free vends associated with the vending token. If the quantity of free vends remaining is greater than zero, then the vending token is permitted to be redeemed for a free vend. The quantity of free vends may be limited to a certain number of free vends per member, or a certain number of free vends for a vendor. After providing the free vend, the remaining quantity of free vends for the member and/or vendor is decremented.

In embodiments where the vending tokens are billable tokens, determining whether the vending token may be redeemed by the customer can include determining the authorized users associated with the vending token. If the member is one of the authorized users for the billable token, then the vending token is permitted to be redeemed for a free vend. The authorized users may be specified by the purchaser of the billable token. For example, a first user may purchase a billable token, and configure a second user as one of the authorized users for the billable token. After providing the free vend, a usage counter associated with the vending token can be increments. The owner of the billable token can be invoiced by generating a bill according to the usage counter of the vending token.

In embodiments where the vending tokens are promotional tokens, determining whether the vending token may be redeemed by the customer can include determining a valid time range associated with the vending token. If the current time of vending is in the valid time range, then the vending token is permitted to be redeemed for a free vend.

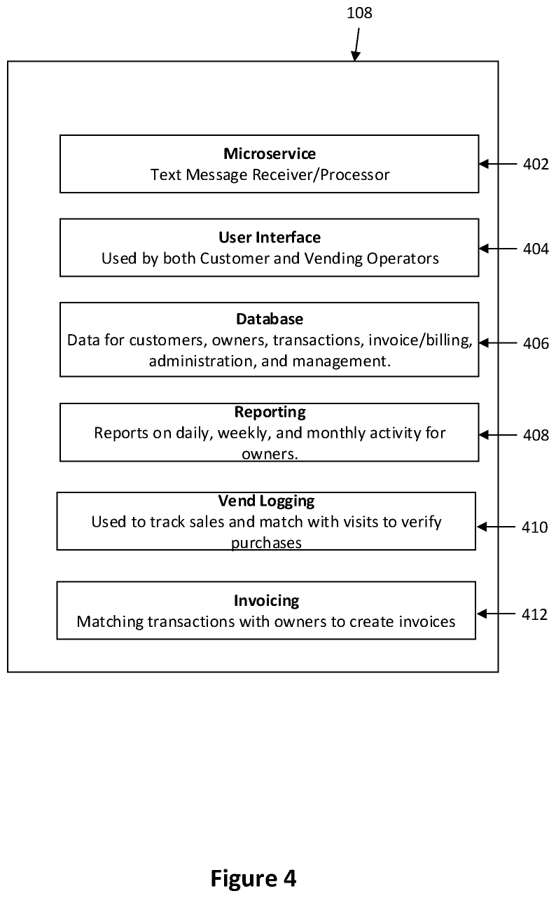

FIG. 4 is a block diagram of the loyalty service 108, in accordance with some embodiments. The loyalty service 108 may be implemented as software or hardware models on a computer system.

The loyalty service 108 comprises an SMS microservice 402, which allows for SMS text message receiving, sending, and processing. The SMS microservice 402 logs all messages and validates virtual token and issues free vends.

The loyalty service 108 further comprises a user interface module 404, which can be used by both customer and vendors. The user interface module 404 may be, e.g., a website. The user interface module 404 has login features for both vendors and customers (e.g., loyalty program members, commercial customers, etc.). Vendors can log in and see the activity for their vending operations, member signing up, vends received, creation of virtual tokens, purchased tokens, etc. Vendors can also send messages to their members individually or as a group. Members may login to view their reward points and referrals. For some types of members (e.g., those with purchased tokens such as commercial customers), the members may view their fund balance, add funds to their prepaid account, add prepaid vends to their account, add authorized users for their tokens, and the like. Members may also customize (or personalize) their unique code rather than using the system-generated code.

The loyalty service 108 further comprises a database module 406, which can be used to store data for customers, vendors, transactions, invoice/billing, administration, management, and the like. The database module 406 can be, e.g., a SQL server. The database module 406 holds all the data associated with the system wo such as customer phone numbers, transactions, virtual tokens, audit logging of users, administration data, system configuration, and the like.

The loyalty service 108 further comprises a reporting module 408. The reporting module 408 reports on daily, weekly, and monthly activity for vendors. Reporting allows vendors to know what activity has transpired during a day, week, or month, to understand marketing activities and associated value.

The loyalty service 108 further comprises a logging module 410. The logging module 410 is used to track sales and match with visits to verify purchases. Specifically, vend logging allows the system 100 to determine that a vend occurred during a reported visit. If so, then the member is given a reward points toward a free vend. If not, the member is notified that a visit requires a purchased vend to earn the reward points.

The loyalty service 108 further comprises an invoicing module 412. The invoicing module 412 is used to match transactions with vendors to create invoices for the vendors.

Some variation of the system 100 are possible. For example, although some embodiments are described as using SMS text messages for the messaging means, any type of technology could be used for messaging. For example, email could be used for messaging. Likewise, inputs from an interactive voice response (WR) system may also be used for the messaging.

In some embodiments, usage data collected for customers is used for SMS text message marketing and/or customer communication. For example, usage data may be analyzed to identify usage patterns for a given customer. The usage patterns may then be used to offer free vends to the customers. Likewise, if the usage patterns indicate the customer is likely to use a vending machine that is out of order, a message may be sent to the customer, notifying them that their normal vending machine is out of order and directing them to another vending machine that is owned by the same vendor. Such analysis and notification sending may be performed manually by a vendor or may be automated.

In some embodiments, GPS coordinates are kept in the database for each vending machine. This allows for a customer to look for the nearest vending machine from their current location. For example, a customer may visit a web page that provides a list of nearby vending machines.

In some embodiments, vendors can send commands from their phone to their vending machines, and also may access a user interface allowing the vendor to administer the system, setup promotions, create promotional coupons or virtual tokens, create purchased tokens and refund tokens. For example, such commands allow the vendor to check the status of their machines, vend products, issue reset commands, and access management features, without the need of an app or a website, as management may be performed via text messages.

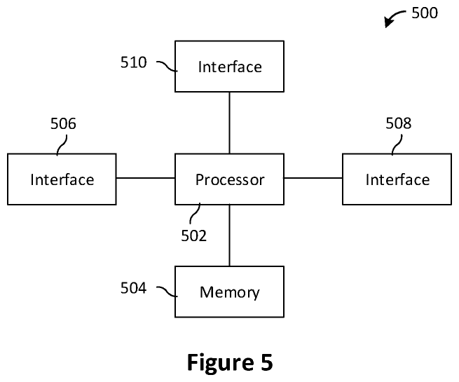

FIG. 5 is a block diagram of a processing system 500 for performing methods described herein, which may be installed in a host device. For example, the phone 102, the phone carrier 104, the SMS text service 106, the loyalty service 108, the database no, the vending facilities 112, the vending machines 114, and/or the vending machine monitoring system 116 may include components similar to the processing system 500. As shown, the processing system 500 includes a processor 502, a memory 504, and interfaces 506, 508, 510, which may (or may not) be arranged as shown in FIG. 5. The processor 502 may be any component or collection of components adapted to perform computations and/or other processing related tasks, and the memory 504 may be any component or collection of components adapted to store programming and/or instructions for execution by the processor 502. In an embodiment, the memory 504 includes a non-transitory computer readable medium. The interfaces 506, 508, 510 may be any component or collection of components that allow the processing system 500 to communicate with other devices/components and/or a user. For example, one or more of the interfaces 506, 508, 510 may be adapted to communicate data, control, or management messages from the processor 502 to applications installed on the host device and/or a remote device. As another example, one or more of the interfaces 506, 508, 510 may be adapted to allow a user or user device (e.g., personal computer (PC), etc.) to interact/communicate with the processing system 500. In some embodiments, one or more of the interfaces 506, 508, 510 connects the processing system 500 to a transceiver adapted to transmit and receive signaling over the system 100. The processing system 500 may include additional components not depicted in FIG. 5, such as long term storage (e.g., non-volatile memory, etc.).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
receiving a short message service (SMS) text message from a first user, the SMS text message comprising a vending token for a vending machine and a source phone number of the first user;
obtaining user data associated with the source phone number;
determining whether the vending token may be redeemed by the first user according to the user data; and
vending a product to the first user from the vending machine in response to determining the vending token may be redeemed by the first user, the vending being performed without requiring payment by the first user to the vending machine at the time of the vending.

2. The method of claim 1, wherein the SMS text message further comprises a destination phone number of the vending machine, and wherein vending the product to the first user from the vending machine comprises:
obtaining vending machine data associated with the destination phone number;
selecting a first interface type for the vending machine from a plurality of interface types according to the vending machine data; and
transmitting a vend command to the vending machine according to the first interface type.

3. The method of claim 2 further comprising:
determining a destination for the vending machine according to the vending machine data,
wherein transmitting the vend command to the vending machine comprises transmitting the vend command to the destination.

4. The method of claim 3, wherein the destination comprises an Internet Protocol address and a port number.

5. The method of claim 2, wherein the source phone number and the destination phone number are long code numbers.

6. The method of claim 1, wherein determining whether the vending token may be redeemed by the first user comprises:
determining a remaining quantity of free vends associated with the vending token;
determining the vending token may be redeemed by the first user in response to the remaining quantity of free vends being greater than zero; and
determining the vending token may not be redeemed by the first user in response to the remaining quantity of free vends being less than or equal to zero.

7. The method of claim 6 further comprising:
decrementing the remaining quantity of free vends.

8. The method of claim 1, wherein determining whether the vending token may be redeemed by the first user comprises:
determining authorized users associated with the vending token;
determining the vending token may be redeemed by the first user in response to the first user being one of the authorized users; and
determining the vending token may not be redeemed by the first user in response to the first user not being one of the authorized users.

9. The method of claim 8 further comprising:
incrementing a usage counter associated with the vending token; and
generating a bill for the first user according to the usage counter of the vending token.

10. The method of claim 1, wherein determining whether the vending token may be redeemed by the first user comprises:
determining a reward point counter associated with the vending token;
determining the vending token may be redeemed by the first user in response to the reward point counter being greater than or equal to a predetermined threshold; and
determining the vending token may not be redeemed by the first user in response to the reward point counter being less than the predetermined threshold.

11. The method of claim 10 further comprising:
validating a purchase by the first user at the vending machine; and
incrementing the reward point counter associated with the vending token in response to validating the purchase.

12. The method of claim 1, wherein determining whether the vending token may be redeemed by the first user comprises:
determining whether the vending token was issued to a second user and whether the first user has previously redeemed the vending token;
determining the vending token may be redeemed by the first user in response to the vending token being issued to the second user and the first user having not previously redeemed the vending token; and
determining the vending token may not be redeemed by the first user in response to the vending token not being issued to the second user or the first user having previously redeemed the vending token.

13. The method of claim 12 further comprising:
incrementing a reward point counter associated with the vending token.

14. The method of claim 1, wherein determining whether the vending token may be redeemed by the first user comprises:
determining a valid time range associated with the vending token;
determining the vending token may be redeemed by the first user in response to the time of the vending being in the valid time range; and
determining the vending token may not be redeemed by the first user in response to the time of the vending not being in the valid time range.

15. A method comprising:
receiving a message comprising a vending token, a source phone number, and a destination phone number;
determining a user associated with the source phone number;
determining a vending machine associated with the destination phone number;
determining whether the user is permitted to redeem the vending token for a free vend of a product from the vending machine;
vending the product to the user from the vending machine in response to determining the user is permitted to redeem the vending token, wherein vending the product comprises:
selecting a first interface type for the vending machine from a plurality of interface types;
determining a destination address for the vending machine; and
transmitting a vend command to the destination address according to the first interface type.

16. The method of claim 15, wherein the message is a short message service (SMS) text message.

17. The method of claim 15, wherein the message is an email.

18. The method of claim 15, wherein the message is an input from an interactive voice response system.

19. A method comprising:
receiving a first message comprising a first vending token and a first destination phone number;
obtaining first user data associated with the first vending token, the first user data comprising a first reward point counter for a first user;
obtaining first vending machine data associated with the first destination phone number, the first vending machine data comprising a first destination address and a first interface type for a first vending machine;
determining whether the first user is permitted to redeem the first vending token for a free vend of a product from the first vending machine; and
transmitting a first vend command to the first destination address according to the first interface type in response to determining the first user is permitted to redeem the first vending token.

20. The method of claim 19 further comprising:
receiving a second message comprising a second vending token and a second destination phone number;
obtaining second user data associated with the second vending token, the second user data comprising a second reward point counter for a second user;
obtaining second vending machine data associated with the second destination phone number, the second vending machine data comprising a second destination address and a second interface type for a second vending machine;
determining whether the second user is permitted to redeem the second vending token for a free vend of a product from the second vending machine; and
transmitting a second vend command to the second destination address according to the second interface type in response to determining the second user is permitted to redeem the second vending token,
wherein the first interface type is different from the second interface type.

21. The method of claim 19 further comprising:
receiving a second message comprising a second vending token and a second destination phone number;
obtaining second user data associated with the second vending token, the second user data comprising a second reward point counter for a second user;
obtaining second vending machine data associated with the second destination phone number, the second vending machine data comprising a second destination address and a second interface type for a second vending machine;
determining whether the second user is permitted to redeem the second vending token for a free vend of a product from the second vending machine; and
transmitting a second vend command to the second destination address according to the second interface type in response to determining the second user is permitted to redeem the second vending token,
wherein the first interface type and the second interface type are the same interface type.
